(19) United States
(12) Patent Application Publication
(10) Pub. No.: US 2008/0082760 A1
(43) Pub. Date: Apr. 3, 2008

(54) EVENT HOLDING CIRCUIT

(75) Inventor: Tatekuni Onoue, Kanagawa (JP)

Correspondence Address: NEC CORPORATION;INTELLECTUAL PROPERTY DIVISION, 7-1 SHIBA 5-CHOME MINATO-KU, TOKYO, 108-01, omitted

(73) Assignee: FUJITSU LIMITED, Kanagawa (JP)

(21) Appl. No.: 11/829,365

(22) Filed: Jul. 27, 2007

(30) Foreign Application Priority Data
Sep. 29, 2006 (JP) 2006269073

(51) Int. Cl. G06F 12/00

(52) U.S. Cl. 711/149; 711/E12.001

(57) ABSTRACT

An event holding circuit configured to monitor plural monitored boards, write collected event information, and hold the event information until a processor reads the event information, the event holding circuit includes a holding circuit including an OR gate, so that a logical sum output of the collected event information and holding event information is written in a memory where written contents until the last time have been read from an address area of the memory where the event information is to be written.

### BACKGROUND OF THE INVENTION

1. Field of the Invention

The present invention generally relates to event holding circuits, and more specifically, to an event holding circuit whereby plural monitored boards such as main signal boards are monitored by a monitoring board in a transmission apparatus or the like and received event information such as alarm information is held.

2. Description of the Related Art

FIG. 1 is a block diagram of a related art transmission apparatus.

As shown in FIG. 1, for example, a transmission apparatus includes a monitoring board and plural monitored boards 102 such as main signal boards. The monitoring board 101 collects, in order, status information of the monitored boards 102 of #1 through #m so as to monitor the status of the monitored board 102. The monitoring board 101 includes a processor (CPU) 103 and a monitored control interface part 104. The processor 103 performs monitoring control. The monitored control interface part 104 implements selective connection of the m monitored boards 102 with a sending timing generation part 105, a sending part 106, and a receiving part 107. The monitored control interface part 104 includes a serial interface part 108 and a dual port memory (DP-RAM) 109. The serial interface part 108 has a conversion function between serial data and parallel data.

The processor (hereinafter “CPU”) 103 inputs a control signal of start sending to the sending timing generation part 105 configured to generate sending timing to the monitored boards 102. The sending timing generation part 105 sends a start sending notification and reading data for reading status information from the monitored boards 102. The sending timing generation part 105 also sends path setting information for selectively designating the monitored boards 102 to the serial interface part 108. The sending timing generation part 105 also sends a receiving notification to the CPU 103 following a receiving completion notification from the receiving part 107. Based on the receiving notification from the sending timing generation part 105, the CPU 103 sends a control signal of next start sending to the sending timing generation part 105 of the monitored board 102. An address, a control signal and data are received and sent between the CPU 103 and the dual port memory (hereinafter “DP-RAM”) 109. In other words, event information (status information) corrected from the monitored boards 102 are written in and held by the DP-RAM 109 and the CPU 103 reads the event information so that a monitoring process of the monitored board 102 is implemented.

The serial interface part 108 includes serial and parallel conversion parts configured to mutually convert the serial data and the parallel data. The serial interface part 108 converts sending data from the sending part 106 into the serial data and sends the serial data to the monitored board 102 selected based on the path setting information from the sending timing generation part 105. The selected monitored board 102 sends the status information as the serial data. The serial interface part 108 converts the received serial data into the parallel data and forwards it to the receiving part 107. When the receiving part 107 completes receiving the serial data as the event information, the serial interface part 108 forwards the receiving completion notification to the sending timing generation part 105 and inputs a writing control signal and writing data as the event information to the DP-RAM 109. When the CPU receives the receiving notification from the sending timing generation part 105, the CPU 103 inputs an address signal and a control signal to the DP-RAM 109. The CPU 103 reads the event information held in the DP-RAM 109 as data and performs a monitoring process of the monitored control board 102.

FIG. 2 is a sequence diagram of an example of processing operations by the CPU 103, the monitored control interface part 104, and the monitored board 102. In FIG. 2, (1) through (17) indicates the order of the processing operations.

First, the CPU 103 writes the setting parameter in the DP-RAM 109 by using the data, the address, and the control signal as shown in FIG. 1 (1). The setting parameter includes path information designating a path where the monitored board 102 is connected, a receiving time-out value indicating allowable time until the event information is completed being received from the monitored board 102, a single or plural cell numbers. in the monitored board 102 (See Cell of the DP-RAM 109 discussed below), and others.

The CPU 103 implements a sending notification (notification by a hard line) to the sending timing generation part 105 of the monitored control interface part 104 (2). This sending notification is a control signal indicating “start sending” from the CPU 103 to the sending timing generation part 105 of the monitored control interface part 104.

The monitored control interface part 104 receives the sending notification from the CPU 103 (3). The monitored control interface part 104 reads the setting parameter from the DP-RAM 109 (4) and selects a subject package (monitored board) based on the path information (5). The monitored control interface part 104 generates the serial frame as the process (6) and sends the serial frame (7).

The monitored board 102 receives the serial frame from the serial frame interface part 108 (8) and sends the serial frame including the alarm information to the serial interface part 108 (10) as a process of (9).

The monitored control interface part 104 receives the serial frame including the alarm information from the monitored board (11) and analyzes the serial frame and performs data generation based on the analysis as a process (12). The monitored control interface part 104 writes the data in the DP-RAM 109 as the event information and sends IRQ (Interrupt Request) to the CPU 103.

The CPU 103 detects the IRQ from the monitored control interface part 104 (15). The CPU 103 sends an IRQ identification flag to the monitored control interface part 104 as a CPU AK (15.2).

The monitored control interface part 104 lifts the IRQ sent to the CPU 103 (15.4). The CPU 103 confirms an error (16) and reads the alarm information of the path to which the DP-RAM 109 corresponds (17).

FIG. 3 is a view showing the DP-RAM 109 and shows an example where there are 32 (#1 through #32) monitored boards 102. A holding area of the event information corresponding to each of the #1 through #32 monitored boards 102 is formed by 8 cells, namely Cell 0 through Cell 7. Each of the cells has 256 bits in total of (D0 through D7)×32. Each of the bits, STx (ST0 through ST255) corresponds to one of parts in the monitored board 102 in advance. For example, the event information of the monitored board 102 can be stored where “1” is defined as an alarm or status-on and “0” is defined as an alarm or status-off. Therefore, in a case of the DP-RAM 109 shown in FIG. 3, at least 8,195 bits are necessary for storing the received event information from 32 monitored boards 102.

In order to take the information of the monitored board 102 in, the CPU 103 of the monitored board 101 writes the path information (information indicating the path to which one of the #1 through #32 monitored boards 102 is connected), the Cell No., the event information, or the control information in an area other than a storing area of the event information of the DP-RAM 109. A notification of start sending from the CPU 103 is sent to the monitored control interface part 104 as the sending notification of (2) of FIG. 2 so that the notification is forwarded from the sending timing generation part 105 of the monitored control interface part 104 to the sending part 106 as the start sending notification. The sending part 106 reads the information stored in the DP-RAM 109, identifies the path to be used, namely the path to the monitored board 102, reads the data such as Cell No. stored in the DP-RAM 109, converts it into the serial data in the serial interface part 108, and sends it to the monitored board 102. The monitored board 102 sends the status information corresponding to the requested Cell No. and others, namely the event information to the monitoring board 101 as serial data.

Therefore, in order to obtain information of all of the monitored boards 102, the CPU 103 of the monitoring board 101 repeats sending and receiving information such as start sending or receiving notification to and from the monitored control interface part 104. Hence, the processing workload of the CPU 103 is increased. Accordingly, a structure where a poling operation is autonomously implemented by the sending timing generation part 105 of the monitored control interface part 104 has been suggested. Such a structure is shown in FIG. 4.

Here, FIG. 4 is a block diagram of another related art case where polling is applied. In FIG. 4, parts that are the same as the parts shown in FIG. 1 are given the same reference numerals.

The sending timing generation part 105 of the monitored control interface part 104 forwards the start sending notification to the sending part 106 at a poll-interval that is set in advance without receiving the notification of start sending from the CPU 103. The sending part 106 in this example, as well as the example shown in FIG. 1, sends the sending data as the serial data from the serial interface part 108 to the monitored board 102 selected based on the path setting. The information from the monitored board 102, namely the event information is forwarded from the serial interface part 108 to the receiving part 107 as the receiving data. The receiving part 107 inputs the receiving data to the DP-RAM 109 as writing data together with the writing control signal. The writing data are stored in the DP-RAM 109 as the event information. The CPU 103 implements reading control of the event information stored in the DP-RAM 109 at timing different from the poll-interval by the sending timing generation part 105. Therefore, since the CPU 103 does not send and receive the start sending or receiving notification to and from the monitored control interface part 104, the processing workload of the CPU 103 may be decreased.

FIG. 5 is a sequence diagram of processing operations by the polling. FIG. 5(A) shows the processing operations of the CPU 109, the monitored control interface part 104, and the monitored part 102 corresponding to FIG. 2. FIG. 5(B) shows an example of the poll-interval.

The monitored control interface part 104 automatically increments the path and the cell No. at a sending interval that is set by the sending timing generation part 105 (1), and sends the sending notification from the sending timing generation part 105 to the sending part 106 (2). The processes (3) and (4) shown in FIG. 2 are omitted. The monitored control interface part 104 selects a subject package (monitored board 102) based on the path information (5). The monitored control interface part 104 generates the serial frame as the process (6) and sends the serial frame to the monitored board 102 (7).

The monitored board 102 receives the serial frame from the serial frame interface part 108 (8) and sends the serial frame including the alarm information to the serial interface part 108 (10) as a process of (9).

The monitored control interface part 104 receives the serial frame including the alarm information from the monitored board (11) and analyzes the serial frame and performs data generation based on the analysis as a process (12). The monitored control interface part 104 writes the data in the DP-RAM 109 as the event information. The processes (14) and (15.4) shown in FIG. 2 are omitted. The CPU 103 confirms an error (16) and reads the alarm information of the path to which the DP-RAM 109 corresponds (17).

In a case where the poll-interval of the start sending notification from the sending timing generation part 105 to the sending part 106 is, for example, 100 ms as shown in FIG. 5(B), in order to read the information collected from the monitored board 102, the poll-interval by the CPU 103 of the DP-RAM 109 can be, for example, 250 ms that is longer than the poll-interval of the start sending notification. Therefore, it is not necessary for the CPU 103 to implement start sending to the sending timing generation part 105 at an interval corresponding to the poll-interval. A process for reading the event information held in the DP-RAM 109 may be implemented by the monitored control interface part 104. Hence, it is possible to reduce the processing workload of the CPU 103.

In the meantime, Japanese Laid-Open Patent Application Publication No. 59-90152 describes means for performing high speed logic simulation as event process means in the logic simulation. In the means, the event is recorded in a free storage of an event memory for recording and extracting the event. Its address is recorded in a position corresponding to an event extracting time in an index resister. The event following the present time of the logic simulation is extracted. An event process part is realized in hardware so that the logic simulation is made to have high speed.

Japanese Laid-Open Patent Application Publication No. 7-90152 describes the following structure. That is, generated external events 1-n are held by an external event holding circuit, and an event generation report signal corresponding to each event is transmitted to a delay circuit. The delay circuit delays an interrupt signal to be transmitted to a CPU for a fixed time and receives the plural events during that time. The CPU, which receives the interrupt signal, successively processes the received plural events and when the processing is completed, the CPU transmits a reset instruction to a reset circuit and resets the external event holding circuit and the delay circuit.

The processor does not directly start for correcting the event information but, as shown in FIG. 4, the sending timing generation part 105 automatically implements the polling for correcting the event information, so that the processing workload of the processor can be reduced. In this case, as shown in FIG. 5, it is general practice that the poll-interval by the sending timing generation part 105 is shorter than the poll-interval for the CPU 103 to read the event information from the DP-RAM 109. In addition, the address area where the event information is read from the DP-RAM 109 is cleared and new event information can be written in the cleared address area. Furthermore, in a case where the collected event information is written in the same address area as the area where the event information is held before the event information is read, the held event information is deleted and the collected new event information is written. Therefore, it is necessary to hold the event information collected from the monitored board 102 in the DP-RAM 109 so as not to delete it until the CPU 103 reads it. Because of this, it is necessary to provide data holding means other than the DP-RAM 109 for holding the collected event information. A structure using flip-flops is the general practice for such data holding means. However, as shown in FIG. 3, for example, the amount of the collected event information is equal to or greater than 256 bytes and therefore it is necessary to provide a large number of the flip-flops. Because of this, circuit size and cost are increased.

### SUMMARY OF THE INVENTION

Accordingly, embodiments of the present invention may provide a novel and useful event holding circuit solving one or more of the problems discussed above.

More specifically, the embodiments of the present invention may provide an event holding circuit whereby event information can be held under a simple structure.

One aspect of the present invention may be to provide an event holding circuit configured to monitor plural monitored boards, write collected event information, and hold the event information until a processor reads the event information, the event holding circuit including a holding circuit including an OR gate, so that a logical sum output of the collected event information and holding event information is written in a memory where written contents until the last time have been read from an address area of the memory where the event information is to be written.

According to the above-mentioned event holding circuit, it is possible to hold event information under a simple structure.

Other objects, features, and advantages of the present invention will be come more apparent from the following detailed description when read in conjunction with the accompanying drawings.

### BRIEF DESCRIPTION OF THE DRAWINGS

FIG. 1 is a block diagram of a related art transmission apparatus;

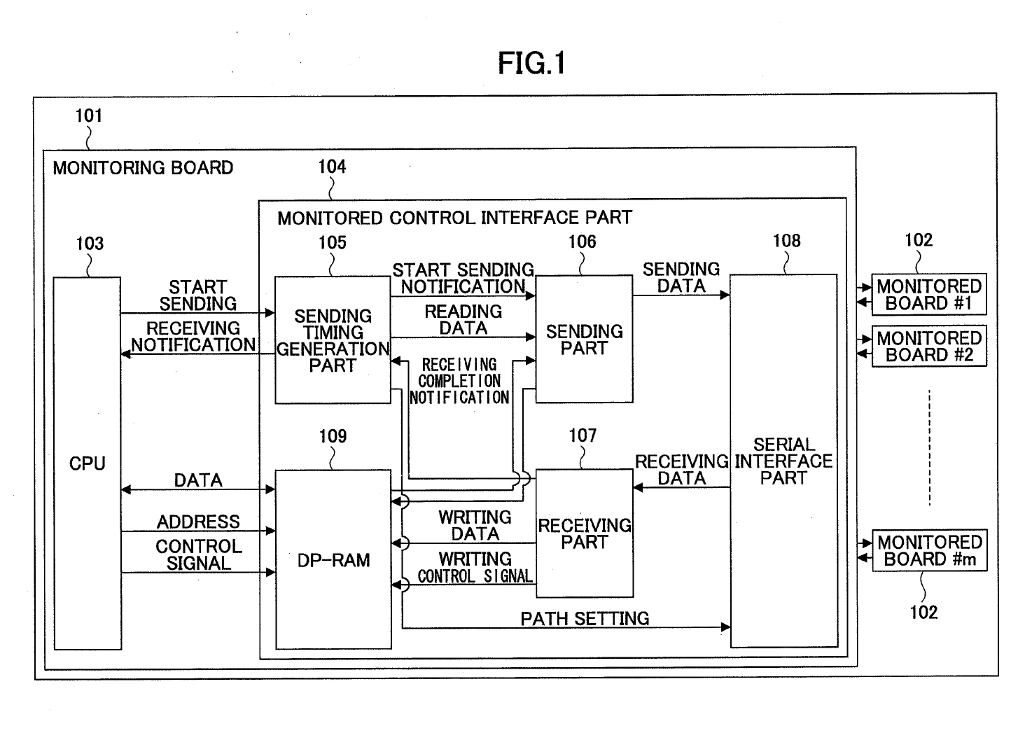

FIG. 2 is a sequence diagram of processing operations in the related art;

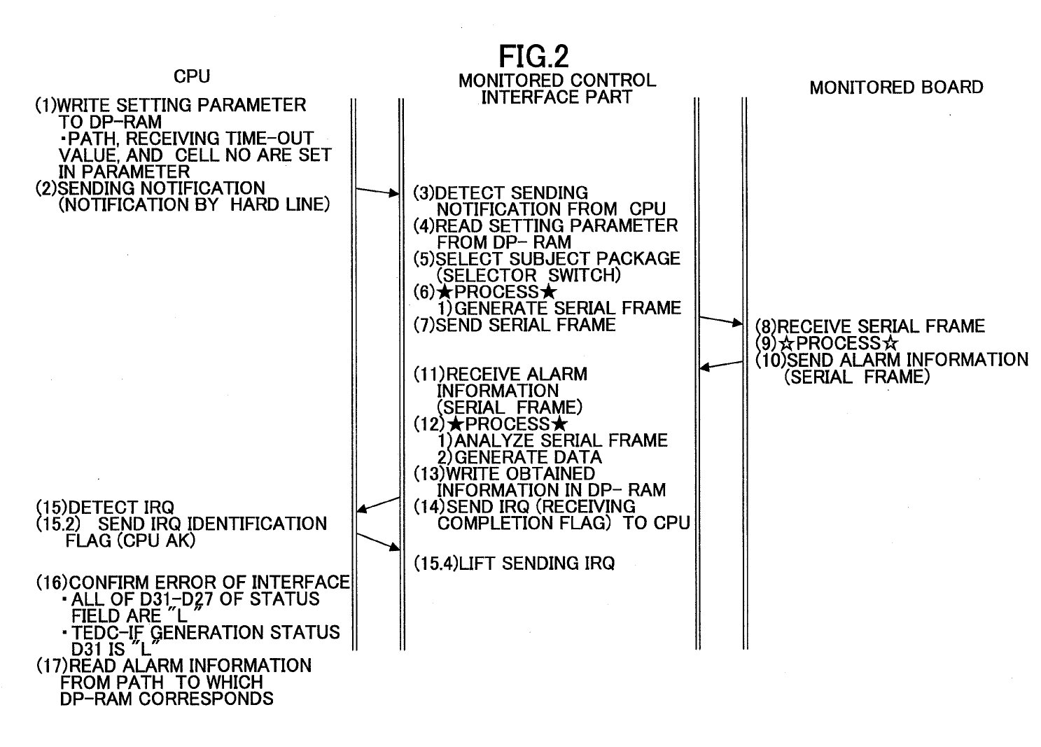

FIG. 3 is a view showing a memory in the related art;

FIG. 4 is a block diagram of another related art case where polling is applied;

FIG. 5 is a sequence diagram of processing operations by the polling;

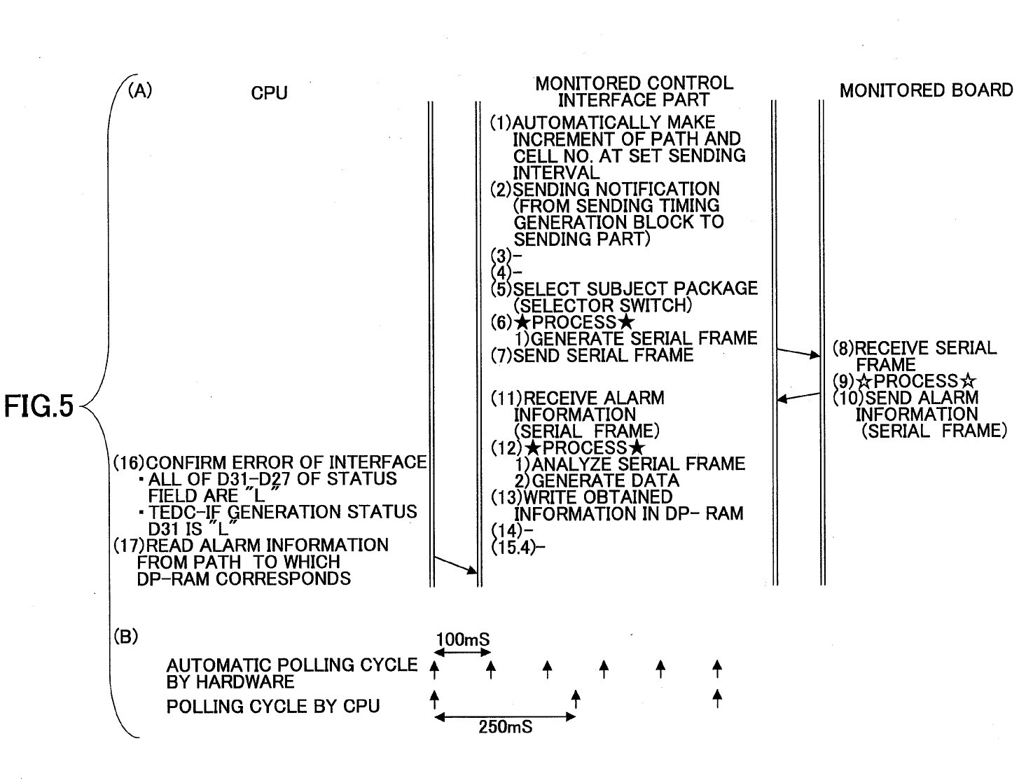

FIG. 6 is a block diagram for explaining an embodiment of the present invention;

FIG. 7 is a timing chart of a holding circuit of the embodiment of the present invention; and

FIG. 8 is a timing chart of a clear circuit of the embodiment of the present invention.

### DETAILED DESCRIPTION OF THE PREFERRED EMBODIMENTS

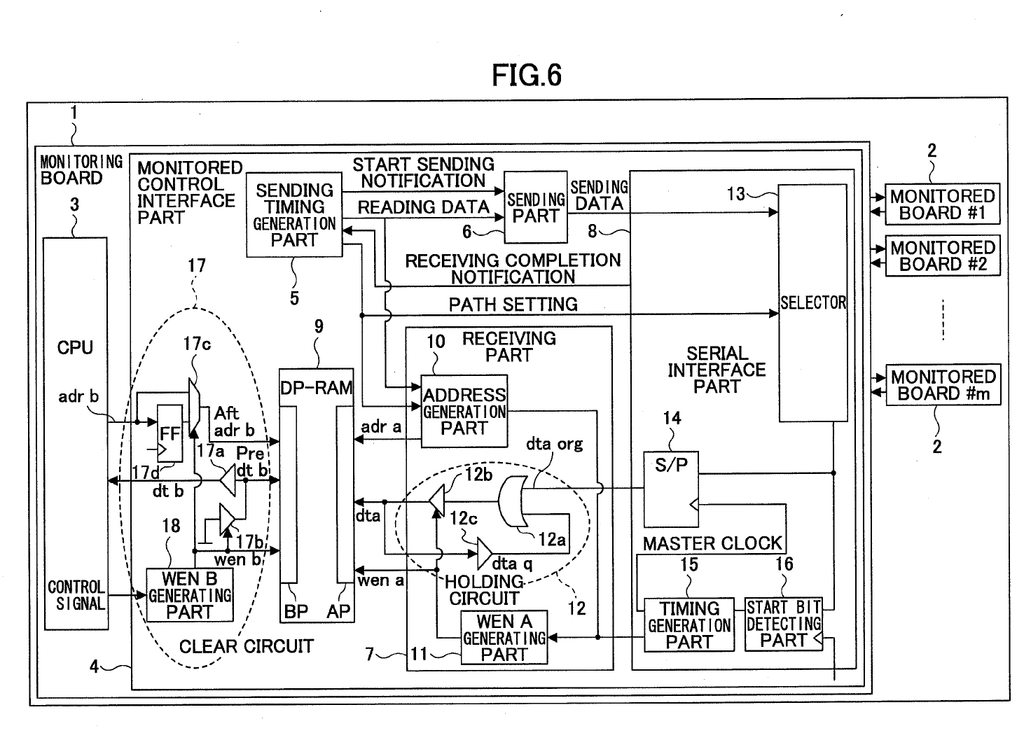

A description is given below, with reference to the FIG. 6 through FIG. 8 of embodiments of the present invention.

FIG. 6 is a block diagram for explaining an embodiment of the present invention. Referring to FIG. 6, in an event holding circuit of the embodiment of the present invention, plural monitored boards 2 such as main signal boards are monitored by a monitoring board 1. Collected event information such as alarm information is written and held in a memory such as a DP-RAM 9 until a processor 3 reads it out. The event holding circuit of the embodiment of the present invention has a holding circuit 12 including an OR gate, so that a logical sum output of the collected event information and holding event information is written in a memory where written contents until the last time have been read from an address area of the memory where this event information to be written.

### First Embodiment of the Present Invention

In FIG. 6, “1” denotes a monitoring board. “2” denotes monitored boards of #1 through #m. “3” denotes a CPU. “4” denotes a monitored control interface part. “5” denotes a sending timing generation part. “6” denotes a sending part and “7” denotes a receiving part. “8” denotes a serial interface part. “9” denotes a DP-RAM. “AP” denotes an A port and “BP” denotes a B port. “10” denotes an address generating part. “11” denotes a WENA generating part (write enable signal generating part A). “12” denotes a holding circuit. “12a” denotes an OR gate, “12b” denotes a buffer gate, and “12c” denotes a buffer. “13” denotes a selector. “14” denotes a serial and parallel conversion part (S/P). “15” denotes a timing generation part. “16” denotes a Startbit detecting part. “17” denotes a clear circuit. “17a” denotes a buffer; “17b” denotes a buffer gate; “17c” denotes a selector; “17d” denotes a flip-flop (FF) as an address holding part. “18” denotes a WENA generating part (write enable signal generating part B). “adra”, “adrb”, and “Aftadrb” denote address signals (address information). “dtaorg”, “dtaq”, “dta”, “dtb”, or “Prdtb” denote data. “wena” and “wenb” denote enable signals. While the enable signals “wena” and “wenb” should be the write enable signals, in a case where read enable signals are necessary, they may be input to the DP-RAM 9 by known means.

The receiving part 7 includes the address generating part 10, the WENA generating part 11 configured to generate the enable signal “wena”, and the holding circuit 12.

The serial interface part 8 includes the selector 13, the serial and parallel conversion part (S/P) 14, the Start bit detecting part 16, and the timing generating part 15.

The clear circuit 17 is provided at the B port BP of the DP-RAM 9 where the processor 3 is connected. The clear circuit 17 includes the buffer 17a, the buffer gate 17b, the selector 17c, the flip flop 17d, the WENB generating part 18 configured to generate the enable signal “wenb”. The serial interface part 8 has a serial and parallel switching part (not shown in FIG. 6) provided at a front step of the selector 13 so that the sending data from the sending part 6 can be converted from the parallel date to the serial data.

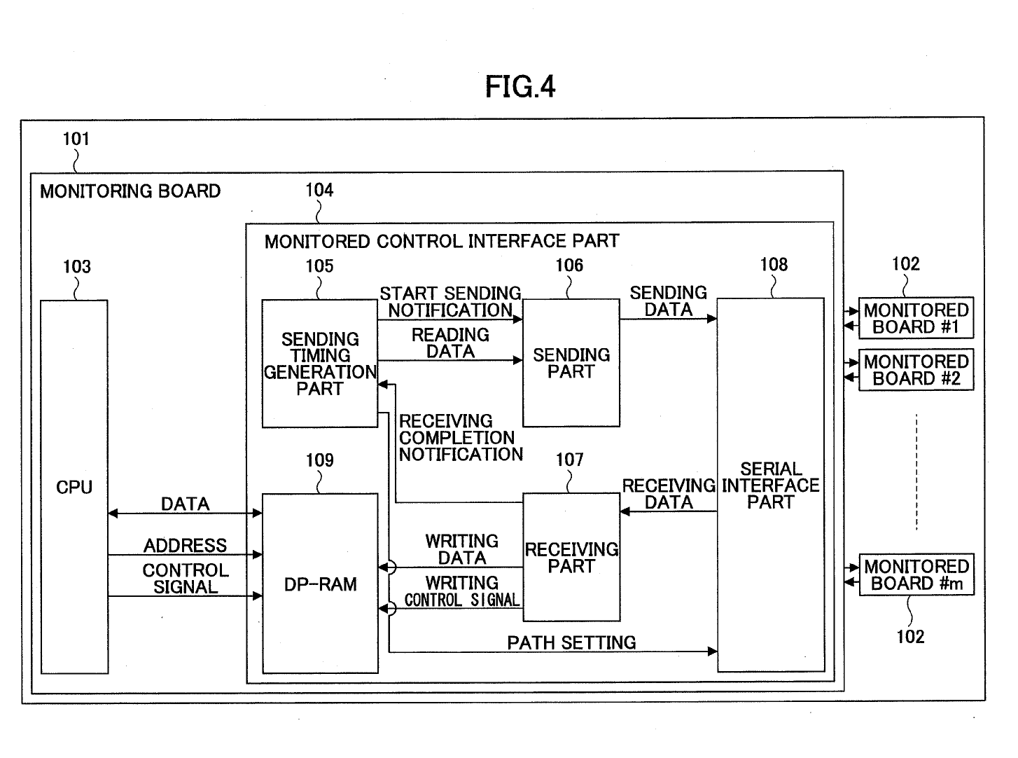

The sending timing generation part 5, as well as the sending timing generation part 105 shown in FIG. 4, sends a start sending notification to the sending part 6 at a designated polling interval without receiving the instruction to start sending from the CPU 3. The sending timing generation part 5 inputs reading data indicating the contents (kinds) of the information collected from the monitored boards 2 to the sending part 6 and the address generation part 10 of the receiving part 7. The sending timing generating part 5 inputs the path setting information selecting the #1 through #m monitored boards 2 to the address generation part 10 of the receiving part 7 and the selector 13 of the serial interface part 8. The serial interface part 8 converts the sending data from the sending part 6 into the serial data by using the parallel and serial conversion part not shown in FIG. 6. The serial interface part 8 selects the monitored board 2 following the path setting information from the sending timing generation part 5 by using the selector 13 and sends the serial data.

When the serial data including the alarm information from the monitored board 2 are received at the serial interface part 8 of the monitoring board 1, the serial data are forwarded from the selector 13 to the serial and parallel conversion part 14 and the Start bit detecting part 16. When the Start bit detecting part 16 detects the Start bit, the detection signal of the Start bit is output to the timing generation part 15. The timing generation part 15 generates a master clock that is timing-synchronized with the Start bit so as to output it to the serial and parallel conversion part 14. The serial and parallel conversion part 14, following the master clock, converts the serial data from the selector 13 to the parallel data and forwards receiving data dtaorg as the parallel data to the receiving part 7. The timing signal that is output from the timing generation part 15 is input to the WENA generation part 11 and the address generation part 10 of the receiving part 7.

If the event information collected at the address area is written before the CPU 3 reads from the B port BP side of the DP-RAM 9, the holding event information previously written is rewritten (overwritten). Hence, it is necessary to hold the holding event information previously written until the CPU 3 reads it. Because of this, the holding circuit is formed by a logic circuit including the OR gate 12a so that the holding information that is previously written data can be held until the CPU 3 reads the data that are the event information. When the CPU 3 reads the data that are the event information, the data of the address area, namely the holding event information is cleared by the clear circuit 17. The address generation part 10, the WENA generation part 11, and the holding circuit 12 are connected to the A port AP where the event information of the DP-RAM 9 is written. While the holding circuit 12 has a structure corresponding to the number of bytes of the receiving data dtaorg, the holding circuit 12 can be realized under a simple structure, namely the OR gate 12a, the buffer 12b, and the buffer gate 12c.

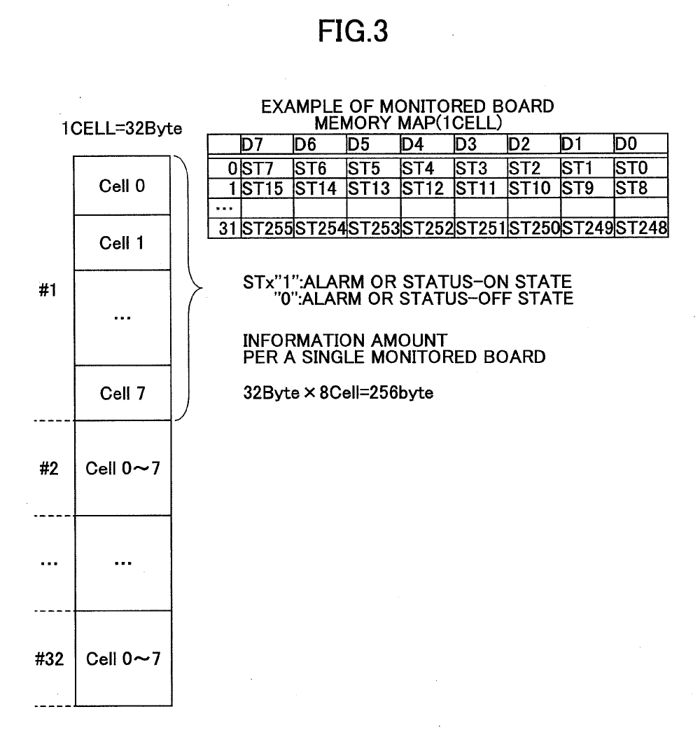

For example, in a case where the data Cell 3 (See FIG. 3) of the monitored board #2 is collected, the start sending notification, the reading data, and the path setting data are output from the sending timing generation part 5 and the sending part 6. The sending data include the cell number (Cell 3). The sending data including the information of the cell number are output from the sending part 6 to the serial interface part 8. The selector 13 of the serial interface part 8 selects the path where the above-mentioned monitored board #2 is connected, following the path setting data from the sending timing generation part 5. As a result of this, the serial data including the cell number (Cell 3) required to obtain the event information is sent from the serial interface part 8 to the monitored board #2. The address generation part 10, based on the cell number included in the reading data from the sending timing generation part 5 and the path setting data, prepares to generate the address signal adra designating the cell number (Cell 3) of the monitored board #2.

When the serial data of the response from the monitored board #2 are received by the serial interface part 8, as discussed above, the start bit of a head of the serial data is detected by the Startbit detection part 16, the master clock synchronized with the detection signal is generated by the timing generation part 15, and the master clock is input to the serial and parallel conversion part 14. The received serial data are converted to the parallel data by the serial and parallel conversion part 14 so as to be input to the holding circuit 12. The timing signal from the timing generation part 15 is input to the address generation part 10 and the WENA generation part 11.

The address generation part 10, based on the timing signal, inputs the address signal adra designating the cell number (Cell 3) of the monitored board #2 generated and prepared previously to the A port AP of the DP-RAM 9. The address generation part 10 reads the event information from the address area of the address signal adra and inputs it to the buffer 12c of the holding circuit 12. The data dtaq from the buffer 12c and the data dtaorg converted to the parallel data by the serial and parallel conversion part 14 are input to the OR gate 12a.

The enable signal wena generated by following the timing signal from the timing generation part 15 is input to the A port AP of the DP-RAM 9 and the buffer gate 12b by the WENA generation part 11. As a result of this, a logical sum output of the collected event information (dtaorg) and the holding event information (dtaq) is input to the A port AP of the DP-RAM 9 via the buffer gate 12b. The logical sum is written in the address area following the address signal adra from the address generation part 10. A logical sum output of the newly collected event information and the event information before the CPU 3 reads it is written in the DP-RAM 9 so as to be capable of being held.

It is general practice that the clear process of the memory is implemented by writing “0” from the CPU 3. The clear circuit 17 is provided in order to reduce the processing workload of the CPU 3. As discussed above, the clear circuit 17 includes the buffer 17a, the buffer gate 17b, the selector 17c, the flip flop 17d, and the WENB generation part configured to generate the enable signal wenb. The buffer 17a and the buffer gate 17b are provided corresponding to the byte structure of the data Predtb.

When the CPU 3 reads the event information from the DP-RAM 9, the control signal and the address signal of the DP-RAM 9 are output. The selector 17c of the clear circuit 17 selects the flip flop side 17d when the enable signal wenb from the WENB generation part 18 is input. Before that, the selector 17c selects the CPU 3 side. Therefore, the address signal from the CPU 3 is input to the B port BP of the DP-RAM 9 via the selector 17c. The data Predtb (holding event information) is read from the DP-RAM 9 and input to the CPU 3 via the buffer 17a. In other words, the event information held by the DP-RAM 9 can be read by the CPU 3. Just after that, the enable signal wenb from the WENB generation part 18 is input to the selector 17c, the buffer gate 17b, and the DP-RAM 9. As a result of this, the selector 17c selects the flip flop 17d side and the address signal, when the previous holding event information has been read, is input to the B port BP of the DP-RAM 9 as the address signal Aftadrb and “0” is input from the buffer gate 17b to the B port BP of the DP-RAM 9. As discussed above, the address signal when the event information is read from the DP-RAM 9 is held by the flip flop 17d of the clear circuit 17 for a while and “0” is automatically written to the address area where the event information has been read via the buffer gate 17b of the clear circuit 17, so that the clearing process can be applied to the address area of the DP-RAM 9 where the event information has been read.

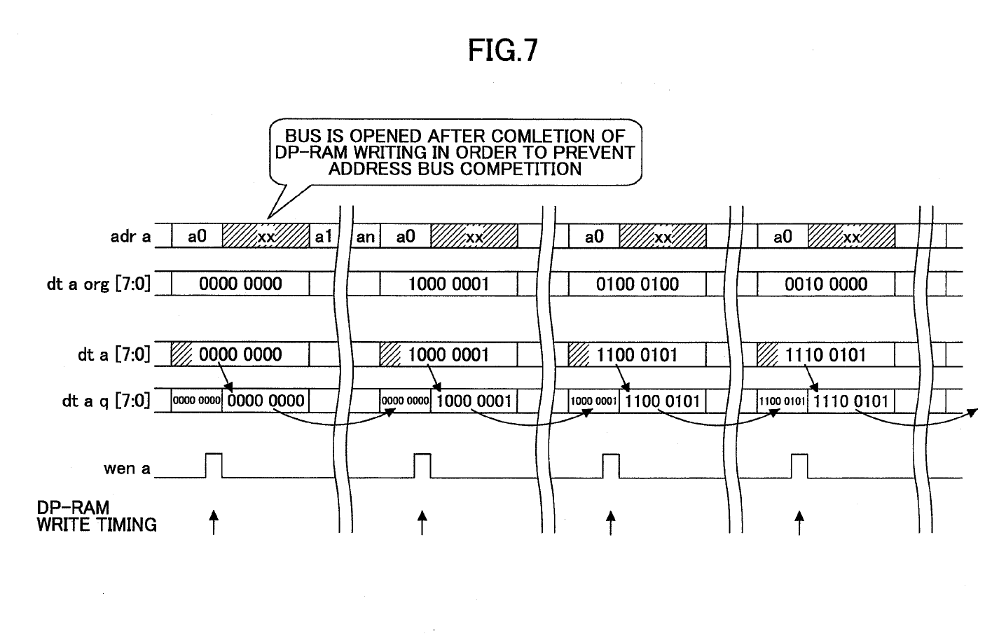

FIG. 7 shows an example of the timing chart of the holding circuit 7. More specifically, FIG. 7 shows the address signal adra from the address generation part 10, the receiving data dtaorg input to the OR gate 12a of the holding circuit 12, the data dta as the event information input to the A port AP of the DP-RAM 9, the data dtaq as the holding event information input to the OR gate 12a via the buffer 12c, the enable signal wena, and the write timing of the DP-RAM 9.

[7:00] indicates, as shown in FIG. 3, a case where the event information has 8 bytes D0 through D7 and a case where the data dtaorg, dta, and dtaq are all “0” in the primary state of collection of the event information. For example, in a case where the address area of 0 through 31 in the Cell 0 of the monitored board #1 of FIG. 3, a0 through an of the address signal adra are indicated as a0 through a31. In addition, xx indicates a state where the address bus is opened after the event information is written. Furthermore, arrows to the data dta and dtaq indicate a time order for inputting the data dta written in the DP-RAM 9 to the OR gate 12a via the buffer 12c.

In the primary state, “0000 0000” is written in a storage area of the event information of the DP-RAM 9. In a case where the address signal adra from the address generation part 10 is indicated as a0 and the collected event information is indicated as data dtaorg=“0000 0000”, “0000 0000” that is a logical sum output of the data dtaorg and the data dtaq that is read from the address area of the address signal adra=a0 and the input to the OR gate 12a is written in the address area of the DP-RAM 9 of the address signal adra=a0 by using a down timing of the enable signal wena as the write timing.

In a case where the collected event information corresponding to the address signal adra=a0 is “1000 0001”, “0000 0000” is held in the address area of the address signal adra=a0. Therefore, the data dta of the logical sum of the data dtaorg and data deaq are “1000 0001” and are written in the address area of the DP-RAM 9 of the address signal adra=a0 at the DP-RAM write timing of down of the enable signal wena. In a case where the next collected event information is dtaorg=“0100 0100”, “1000 0001” is written in the address area of the address signal adra=a0. The data dta of the logical sum of the data dtaq=“1000 0001” and the data dtaog=“0100 0100” are “1100 0101” and written in the address area of DP-RAM 9 of the address signal adra=a0. Similarly, in a case where the collected event information dtaorg is “0010 0000”, the data dta=“1110 0101” are written in the address area of the DP-RAM 9 of the address signal adra=a0. That is, when the reading of the event information is not implemented from the CPU 3, the data dta=“1110 0101” are written in the DP-RAM 0 in order as the logical sum output of the collected event information.

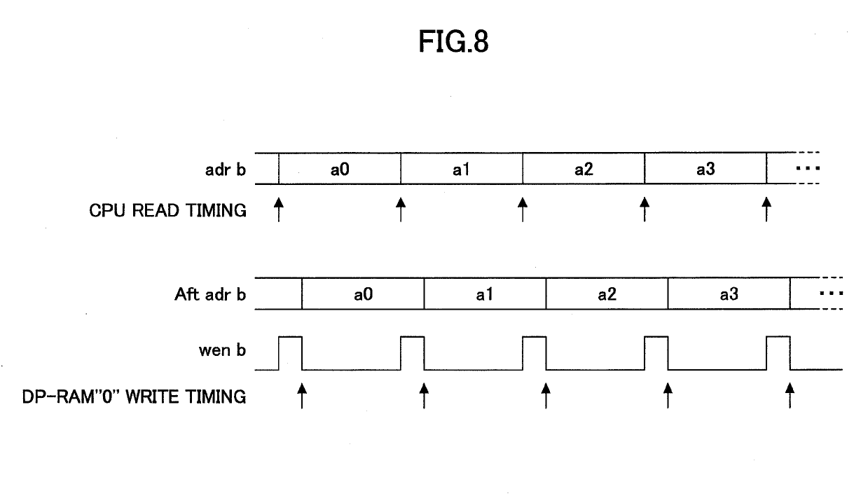

FIG. 8 shows an example of a timing chart of the clear circuit 17. More specifically, FIG. 3 shows the address signals adrb=a0, a1, a2, . . . from the CPU 3, the read timing of the CPU 3, the address signal Aftadrb via the flip flop 17d and the selector 17c, the enable signal wenb from the WENB generation part 18, and the write timing when “0” is written in the DP-RAM 3.

The address signal adrb=a0 is input from the CPU 3 to the selector 17c and the flip flop 17d. The up timing of the enable signal from the WENB generation part 18 is the CPU read timing. When the enable signal wenb is “1”, the buffer gate is closed, the selector 17c selects the CPU 3 side, and the address signal adrb=a0 is input to the B port BP of the DP-RAM 9. As a result of this, the holding event information as data dtb (See FIG. 6) is input to the CPU 3 from the address area of the DP-RAM 9 by the address signal adrb. That is, the CPU 3 can read the desirable event information.

When the enable signal wenb is reduced down to “0”, the down timing is the write timing to the DP-RAM 9. The selector 17c selects the flip flop 17d side by the enable signal wenb=“0”. As a result of this, the address signal adrb=a0 held at the flip flop 17d for a while is input to the B port BP of the DP-RAM 9 and the data of “0” are input to the B port BP of the DP-RAM 9 via the buffer gate 17b. As a result of this, “0” is written to the address area of the address signal Aftadrb=a0 at the timing indicating the DP-RAM “0” write timing. That is, the address area where the holding event information has been read by the CPU 3 can be cleared.

Next, the CPU 3 makes the address signal adrb to a1, a2, at the desirable timing. The holding event information is read from the address area of the DP-RA<9 by the address signal adrb at the CPU read timing. A “0” is written in the address area at the DP-RAM “0” write timing so as to make it clear. Therefore, the clearing process of the DP-RAM 9 by the CPU 3 is not necessary so that the processing workload can be reduced.

The present invention is not limited to these embodiments, but variations and modifications may be made without departing from the scope of the present invention. For example, a normal memory such as a RAM can be used as the DP-RAM 9.

Thus, according to the above-discussed embodiment of the present invention, it is possible to provide an event holding circuit configured to monitor plural monitored boards, write collected event information, and hold the event information until a processor reads the event information, the event holding circuit including a holding circuit including an OR gate, so that a logical sum output of the collected event information and holding event information is written in a memory where written contents until the last time have been read from an address area of the memory where the event information is to be written.

The memory may have a dual port structure having a port at a side where the event information collected from the monitored board is written and a port at a side where the processor reads the event information; the holding circuit may be provided at the port at the side where the collected event information is written; and the holding circuit includes the OR gate whereby the logical sum output of the collected event information and the holding event information may be written as event information to the address area where the written contents until the last time have been read from the address area where the event information is to be written

The event holding circuit as mentioned above may further include a clear circuit configured to hold address information for a while, the address information being at the time when the processor reads the event information from the memory and configured to, following the address information, perform clearing after the event information is read.

The memory may have a dual port memory structure having a port at a side where the event information collected from the monitored board is written and a port at a side where the processor reads the event information; and a clear circuit may be provided at the side where the event information is read, the clear circuit configured to hold address information for a while, the address information whereby the processor reads the event information and configured to, following the address information, make an address area clear, the address area follows the address information after the event information is read.

The clear circuit may include a write enable signal generation part configured to input to the memory a write enable signal for the memory just after the processor reads the event information from the memory; an address holding part configured to hold the address information whereby the processor reads the event information from the memory, for a while; a selector configured to input address information in the memory, the address information being held at the address holding part by the write enable signal from the write enable signal generation part; and a gate circuit configured to input clear data to the memory by the write enable signal from the write enable signal generation part.

According to the above-mentioned event holding circuit, until the event information indicating statuses of each of the monitored boards as byte correspondence is collected and written in the memory so that the processor reads the event information, the event information of the logical sum of the newly collected event information and the held event information is written as new event information in the memory. In this case, the holding circuit can have a simple logic structure of the OR gate or the like of the byte correspondence of the event information. Hence, compared to the flip flops, increase of the circuit size and cost are not required.

The logical sum output of the held event information and the collected new event information is written in the memory and held by the OR gate. Hence, even if the event information is read by the processor for an interval longer than the event information collecting interval, the event information collected until the processor reads the event information from the memory can be held in the memory by functions of the holding circuit. Hence, it is possible to reduce the processing workload of the processor and prevent the collected event information from being eliminated. In addition, since the clear circuit can be realized by the logic circuit, it is possible to reduce the processing workload of the processor without increasing the cost. Furthermore, in a system where the obstacle information at the monitored board is latched and the obstacle information is sent following the event information collection from the monitoring board so that the latch is lifted, since the obstacle information included in the collected event information is held in the memory, it is possible to send the notice to the processor.

This patent application is based on Japanese Priority Patent Application No. 2006-269073 filed on Sep. 29, 2006, the entire contents of which are hereby incorporated by reference.

What is claimed is:

1. An event holding circuit configured to monitor plural monitored boards, write collected event information, and hold the event information until a processor reads the event information, the event holding circuit comprising:
a holding circuit including an OR gate, so that a logical sum output of the collected event information and holding event information is written in a memory where written contents until the last time have been read from an address area of the memory where the event information is to be written.

2. The event holding circuit as claimed in claim 1,
wherein the memory has a dual port structure having a port at a side where the event information collected from the monitored board is written and a port at a side where the processor reads the event information;
the holding circuit is provided at the port at the side where the collected event information is written; and
the holding circuit includes the OR gate whereby the logical sum output of the collected event information and the holding event information is written as event information to the address area where the written contents until the last time have been read from the address area where the event information is to be written

3. The event holding circuit as claimed in claim 1, further comprising:
a clear circuit configured to hold address information for a while, the address information being at the time when the processor reads the event information from the memory and configured to, following the address information, perform clearing after the event information is read.

4. The event holding circuit as claimed in claim 1,
wherein the memory has a dual port memory structure having a port at a side where the event information collected from the monitored board is written and a port at a side where the processor reads the event information; and
a clear circuit is provided at the side where the event information is read, the clear circuit configured to hold address information for a while, the address information whereby the processor reads the event information and configured to, following the address information, make an address area clear, the address area follows the address information after the event information is read.

5. The event holding circuit as claimed in claim 3,
wherein the clear circuit includes:
a write enable signal generation part configured to input to the memory a write enable signal for the memory just after the processor reads the event information from the memory;
an address holding part configured to hold the address information whereby the processor reads the event information from the memory, for a while;
a selector configured to input address information in the memory, the address information being held at the address holding part by the write enable signal from the write enable signal generation part; and
a gate circuit configured to input clear data to the memory by the write enable signal from the write enable signal generation part.

6. The event holding circuit as claimed in claim 4,
wherein the clear circuit includes:
a write enable signal generation part configured to input to the memory a write enable signal for the memory just after the processor reads the event information from the memory;
an address holding part configured to hold the address information whereby the processor reads the event information from the memory, for a while;
a selector configured to input address information in the memory, the address information being held at the address holding part by the write enable signal from the write enable signal generation part; and
a gate circuit configured to input clear data to the memory by the write enable signal from the write enable signal generation part.
